(19) United States
(12) Patent Application Publication
(10) Pub. No.: US 2023/0323585 A1
(43) Pub. Date: Oct. 12, 2023

(54) WASHING MACHINE AND CONTROLLING METHOD FOR SAME

(71) Applicant: SAMSUNG ELECTRONICS CO., LTD., Suwon-si, Gyeonggi-do (KR)

(72) Inventors: Jungchul CHOI, Suwon-si (KR); Sungmo LEE, Suwon-si (KR); Suhwan JI, Suwon-si (KR)

(21) Appl. No.: 18/189,953

(22) Filed: Mar. 24, 2023

Related U.S. Application Data
(63) Continuation of application No. PCT/KR2021/015740, filed on Nov. 2, 2021.

(30) Foreign Application Priority Data
Nov. 3, 2020 (KR) 10-2020-0145338

(51) Int. Cl. D06F 34/08; D06F 33/30

(52) U.S. Cl. CPC D06F 34/08; D06F 2105/48; D06F 33/30

(57) ABSTRACT

A washing machine according to one aspect of the disclosure comprises: a body having a laundry input port; a water tank provided inside the body and for storing water; a drum rotatably provided inside the water tank; a pulsator provided inside the drum and rotating in the direction opposite from the rotational direction of the drum; a first motor providing a driving force to the pulsator; a second motor providing a driving force to the drum; a first inverter controlling a current applied to the first motor; a second inverter controlling a current applied to the second motor and having a temperature sensing function; and a control unit controlling the first inverter such that the rotational speed of the first motor and/or the rotation time per period of the first motor is reduced if the temperature of the second inverter reaches a predetermined first temperature.

### CROSS-REFERENCE TO RELATED APPLICATIONS

This application is a Bypass Continuation of International Application No. PCT/KR2021/015740, filed Nov. 2, 2021, which claims priority to Korean Patent Application No. 10-2020-0145338, filed Nov. 3, 2020, the disclosures of which are herein incorporated by reference in their entirety.

### BACKGROUND

### 1. Field

The disclosure relates to a washing machine and method for controlling the same. More particularly, the disclosure relates to a washing machine equipped with a pulsator in a drum and method for controlling the same.

### 2. Description of Related Art

A washing machine is a machine for washing clothes with electric power, and commonly includes a water tub for storing water and a drum for creating mechanical energy to separate contaminants from the clothes.

The washing machine is equipped with both a drum and a pulsator to improve laundry performance, producing friction by rotating the drum to drop the clothes and simultaneously rotating the pulsator in the opposite direction from the drum.

A motor for giving rotational force to the drum has a load caused by the pulsator that rotates in the opposite direction. Specifically, the clothes rotating in the same direction as the rotational direction of the drum receive resistance due to the opposite rotation of the pulsator, which soon leads to overload on the motor.

### SUMMARY

The disclosure provides a washing machine and method for controlling the same, which prevents overload on a motor caused by opposite rotations between the drum and the pulsator.

According to an aspect of the disclosure, a washing machine includes a main body having a laundry inlet; a water tub arranged in the main body for storing water; a drum arranged to be rotatable in the water tub; a pulsator arranged in the drum and rotating in an opposite direction from a rotational direction of the drum; a first motor configured to provide driving force to the pulsator; a second motor configured to provide driving force to the drum; a first inverter configured to control a current applied to the first motor; a second inverter configured to control a current applied to the second motor and having a temperature detection function; and a controller configured to control the first inverter to reduce at least one of rotation speed of the first motor or rotation time per period of the first motor in response to temperature of the second inverter reaching a preset first temperature.

The controller may control the first inverter to reduce the rotation speed of the first motor to a second rotation speed lower than a first rotation speed, in response to the temperature of the second inverter reaching the preset first temperature, and control the first inverter to reduce the rotation speed of the first motor to a third rotation speed lower than the second rotation speed, in response to the temperature of the second inverter reaching the preset first temperature again after reaching the preset first temperature.

The controller may control the first inverter to reduce the rotation time per period of the first motor by a specified value each time the temperature of the second inverter reaches the preset first temperature.

The controller may control the first inverter to reduce the rotation time per period of the first motor to 0 in response to the temperature of the second inverter reaching a preset second temperature.

The controller may maintain the reduced rotation time per period of the first motor until the end of a course of the washing machine unless the preset first temperature is reached.

The washing machine may further include an input interface configured to receive an operation command from a user; and a memory, and the memory may store the rotation speed maintained of the first motor, and the controller may, on receiving the same operation command after the end of a course of the washing machine, start the course of the washing machine with the rotation time per period maintained of the first motor.

The controller may control the first inverter to reduce the rotation time per period of the first motor to a second rotation time per period less than the rotation time per period, in response to the temperature of the second inverter reaching the preset first temperature, and control the first inverter to reduce the rotation time per period of the first motor to a third rotation time per period less than the second rotation time per period, in response to the temperature of the second inverter reaching the preset first temperature again after reaching the preset first temperature.

The controller may control the first inverter to reduce the rotation time per period of the first motor by a specified value each time the temperature of the second inverter reaches the preset first temperature.

The controller may control the first inverter to reduce the rotation time per period of the first motor to 0 in response to the temperature of the second inverter reaching a preset second temperature.

The controller may maintain the reduced rotation time per period of the first motor until the end of a course of the washing machine unless the preset first temperature is reached.

The washing machine may further include an input interface configured to receive an operation command from a user; and a memory, and the memory may store the rotation speed maintained of the first motor, and the controller may, on receiving the same operation command after the end of a course of the washing machine, start the course of the washing machine with the rotation time per period maintained of the first motor.

The second inverter may include a temperature sensor to detect a temperature of the second inverter itself.

According to an aspect of the disclosure, a method of controlling a washing machine including a second inverter for controlling a current applied to a second motor for providing driving force to a drum, and a first inverter for controlling a current applied to a first motor for providing driving force to a pulsator which rotates in an opposite direction from a rotational direction of the drum includes detecting temperature of the second inverter; and controlling the first inverter to reduce at least one of rotation speed of the first motor or rotation time per period of the first motor in response to the temperature of the second inverter reaching a preset first temperature.

The controlling of the first inverter may include controlling the first inverter to reduce the rotation speed of the first motor to a second rotation speed lower than a first rotation speed, in response to the temperature of the second inverter reaching the preset first temperature, and controlling the first inverter to reduce the rotation speed of the first motor to a third rotation speed lower than the second rotation speed, in response to the temperature of the second inverter reaching the preset first temperature again after reaching the preset first temperature.

The controlling of the first inverter may include controlling the first inverter to reduce the rotation speed of the first motor by a specified value each time the temperature of the second inverter reaches the preset first temperature.

The controlling of the first inverter may include maintaining the reduced rotation speed of the first motor until the end of a course of the washing machine unless the preset first temperature is reached.

The method of controlling the washing machine may further include receiving an operation command from a user; storing the rotation speed maintained of the first motor; and on receiving the same operation command as the operation command after the end of a course of the washing machine, starting the course of the washing machine at the rotation speed maintained of the first motor.

The controlling of the first inverter may include controlling the first inverter to reduce the rotation time per period of the first motor in response to the temperature of the second inverter reaching the preset first temperature.

The controlling of the first inverter may include controlling the first inverter to reduce the rotation time per period of the first motor to a second rotation time per period less than first rotation time per period, in response to the temperature of the second inverter reaching the preset first temperature, and controlling the first inverter to reduce the rotation time per period of the first motor to a third rotation time per period less than the second rotation time per period, in response to the temperature of the second inverter reaching the preset first temperature again after reaching the preset first temperature.

The controlling of the first inverter may include controlling the first inverter to reduce the rotation time per period of the first motor by a specified value each time the temperature of the second inverter reaches the preset first temperature.

According to the disclosure, overload on a motor caused by opposite rotation between a drum and a pulsator may be prevented. Furthermore, according to the disclosure, damage to an inverter caused by overheating may be prevented.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a side cross-sectional view illustrating a schematic configuration of a washing machine, according to an embodiment.

FIG. 2 is a perspective view illustrating a water tub and a driving device in the washing machine shown in FIG. 1.

FIG. 3 is a side cross-sectional view illustrating a drum, a pulsator, and a driving device in the washing machine shown in FIG. 1.

FIG. 4 is a perspective view illustrating a pulsator and a first driving device in the washing machine shown in FIG. 1.

FIG. 5 is a perspective view illustrating a drum and a second driving device in the washing machine shown in FIG. 1.

FIG. 6 is a rear view of the water tub and the driving device shown in FIG. 2.

FIG. 7 is a control block diagram of a washing machine, according to an embodiment.

FIG. 8 is a circuit diagram of a driving circuit included in a driver of FIG. 7.

FIG. 9 is a flowchart of a method of controlling a washing machine, according to an embodiment.

FIG. 10 is diagram referred to for describing the flowchart shown in FIG. 9.

FIG. 11 is a flowchart of a method of controlling a washing machine, according to an embodiment.

FIG. 12 is a diagram referred to for describing the flowchart shown in FIG. 11.

FIG. 13 is a flowchart of a method of controlling a washing machine, according to an embodiment.

FIG. 14 is a diagram referred to for describing the flowchart shown in FIG. 13.

### DETAILED DESCRIPTION

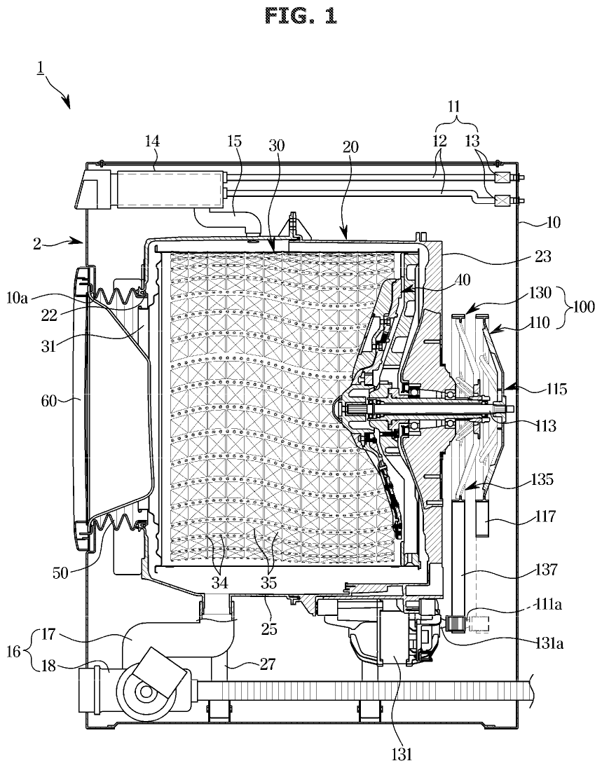

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Like numerals refer to like elements throughout the specification. Not all elements of embodiments of the disclosure will be described, and description of what are commonly known in the art or what overlap each other in the embodiments will be omitted. The term ‘unit, module, member, or block’ may refer to what is implemented in software or hardware, and a plurality of units, modules, members, or blocks may be integrated in one component or the unit, module, member, or block may include a plurality of components, depending on the embodiment of the disclosure.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

Throughout the specification, when it is said that a member is located “on” another member, it implies not only that the member is located adjacent to the other member but also that a third member exists between the two members.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

Reference will now be made in detail to embodiments of the disclosure, which are illustrated in the accompanying drawings.

FIG. 1 is a side cross-sectional view illustrating a schematic configuration of a washing machine, according to an embodiment of the disclosure.

Referring to FIG. 1, a washing machine 1 may include a main body 10 that forms an exterior and receives various components therein, a water tub 20 arranged in the main body 10, a drum 30 for receiving clothes (or referred to as laundry) and rotating, a pulsator 40 arranged in the drum 30, a first driving device 110 for driving the pulsator 40 and a second driving device 130 for driving the drum 30.

The main body 10 may have the form of a box. A laundry inlet 10a through which to put the laundry into the drum 30 may be formed on a front portion 2 of the main body 10.

The laundry inlet 10a of the main body 10 may be opened or closed by a door 60. The door 60 may be rotationally coupled to the main body 10 by a hinge member, and made of a glass member and a door frame supporting the glass member.

The glass member may be formed with a transparent tempered glass substance through which to see the inside of the main body 10. The glass member may be formed to protrude toward the inside of the water tub 20 to prevent the laundry from being concentrated toward the door 60.

The water tub 20 may store water and have a cylindrical shape. The water tub 20 may be supported by a suspension 27. The water tub 20 may include an opening 22 formed on one side to match the laundry inlet 10a of the main body 10, and a rear portion 23 formed on the other side of the water tub 20.

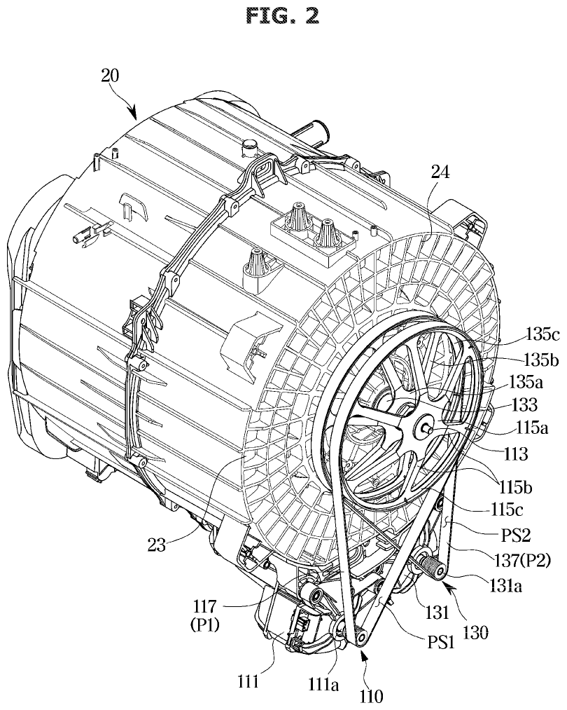

Reinforcing ribs 24 (see FIG. 2) may be formed on the rear portion 23 of the water tub 20 to have a lattice form with constant gaps with each other in radial and circumferential directions. The reinforcing ribs 25 may prevent bending when the water tub 20 is ejected, and prevent a rear wall of the water tub 20 from being twisted due to a load transferred to the water tub 20 during washing or dehydrating.

The laundry inlet 10a of the front portion 2 of the main body 10 may be connected to the opening 22 of the water tub 20 by a diaphragm 50. The diaphragm 50 may define a path connecting the laundry inlet 10a of the main body 10 to the opening 22 of the water tub 20 to guide the laundry put in through the laundry inlet 10a into the drum 30 and diminish vibration that occurs when the drum 30 is rotated being traveled to the main body 10. Furthermore, the diaphragm 50 may seal between the water tub 20 and the glass member of the door 60.

The drum 30 may have an almost cylindrical form with an open front, and may be arranged to be rotated in the tub 20. In other words, the drum 30 may include an opening 31 formed on the front. The drum 30 may be arranged to have a center axis be parallel to a center axis of the water tub 20.

The drum 30 may be rotated in the water tub 20. The drum 30 may do the laundry by lifting and dropping the laundry by being rotated. A lot of through holes 34 may be formed on the circumference of the drum 30 for water contained in the water tub 20 to flow through. Furthermore, the circumference of the drum 30 may include at least one projection 35 protruding through the inside of the drum 30. The projection 35 may improve laundry performance by rubbing the laundry while the laundry is being washed.

In an embodiment, the drum 30 may have a lot of through holes 34 and/or projections 35 consecutively formed across the circumferential plane of the drum 30.

The pulsator 40 may be arranged in a rear portion in the drum 30 to be rotated around the rotation axis. The pulsator 40 converts driving force transferred by the first driving device 110 to rotational force to rotate the laundry.

The rotation axis of the pulsator 40 may correspond to the rotation axis of the drum 30. How to set the rotation axes of the pulsator 40 and the drum 30 is not, however, limited thereto, and in some embodiments, the rotation axes of the pulsator 40 and the drum 30 may be set differently.

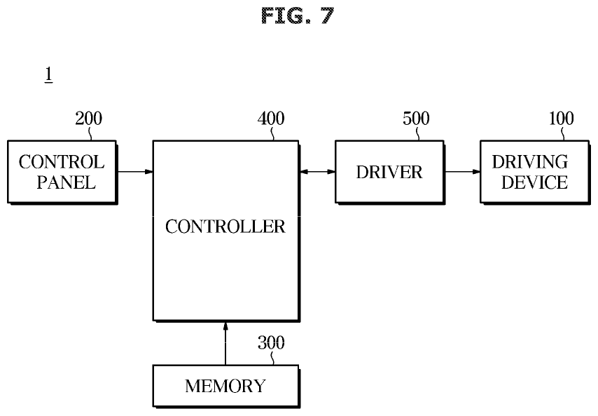

The pulsator 40 may be arranged to make relative rotation in relation to the drum 30. Specifically, the pulsator 40 may be rotated in the same direction with the drum 30 or may be rotated in a different direction from the drum 30. This will be described later in more detail with reference to FIG. 7.

A water supplier 11 for supplying water into the water tub 20 may be arranged above the water tub 20. The water supplier 11 may include a water supply tube 12 through which to supply water from an external water supply source, and a water supply valve 13 for opening or closing the water supply tube 12.

A detergent supplier 14 may be provided in a front upper portion of the main body 10 for supplying a detergent. The detergent supplier 14 may be connected to the water tub 20 through a connection tube 15. Water suppled through the water supply tube 12 may pass through the detergent supplier 14 and may be supplied into the water tub 20 together with the detergent.

The washing machine 1 may include a draining device 16 underneath a bottom portion 25 of the water tub 20 to drain water. The draining device 16 may include a drain tube 17 connected to the bottom of the water tube 20 to guiding the water to the outside of the main body 10, and a drain pump 18 for pumping the water in the water tub 20.

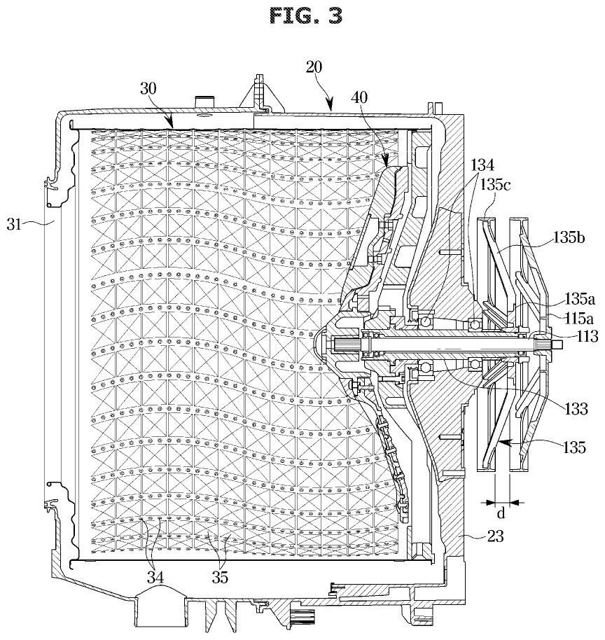

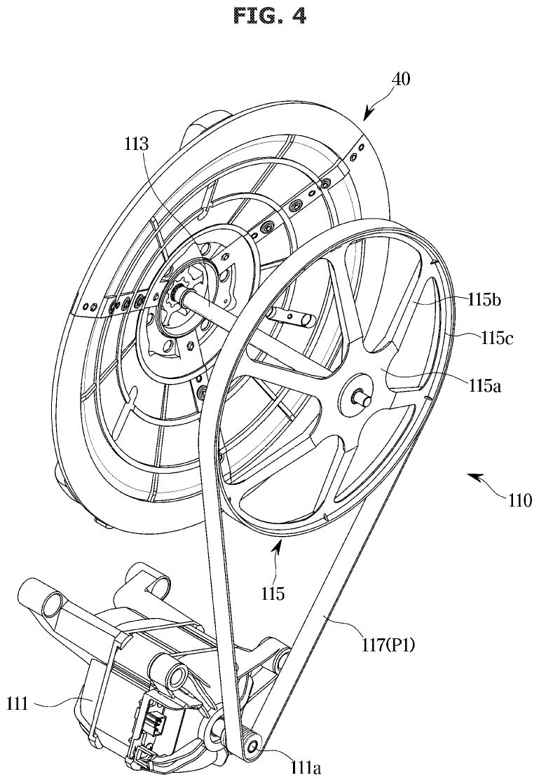

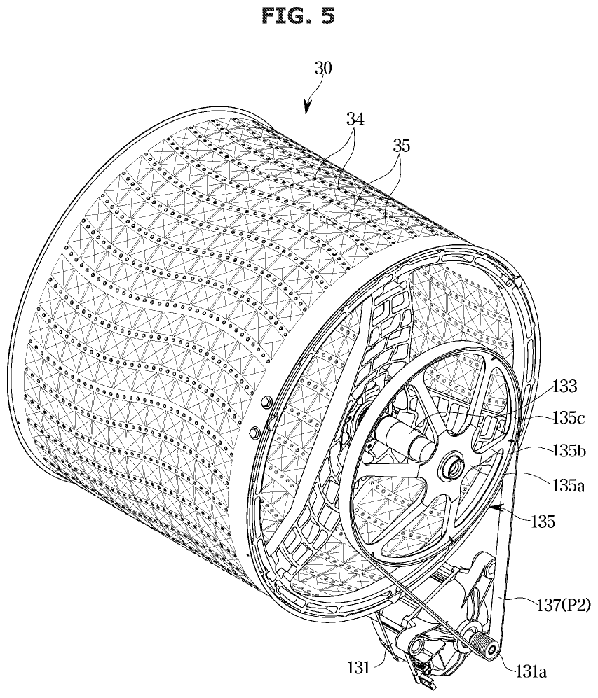

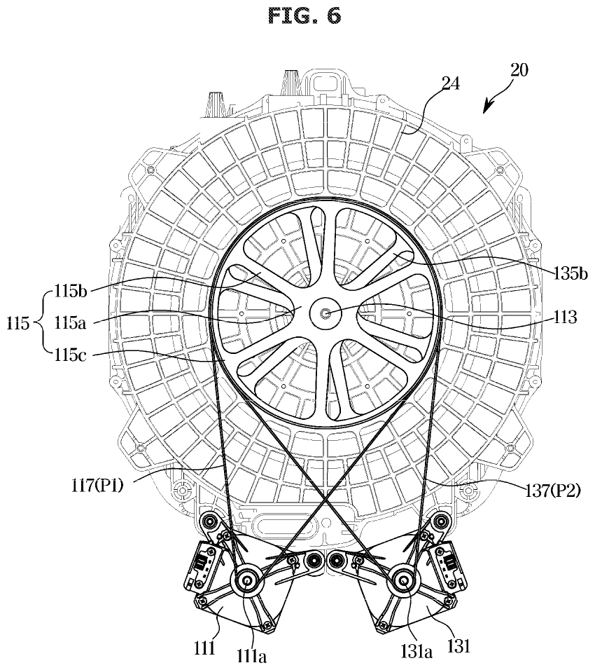

FIG. 2 is a perspective view illustrating the water tub and the driving device in the washing machine shown in FIG. 1. FIG. 3 is a side cross-sectional view illustrating the drum, the pulsator, and the driving device in the washing machine shown in FIG. 1. FIG. 4 is a perspective view illustrating the pulsator and the first driving device in the washing machine shown in FIG. 1. FIG. 5 is a perspective view illustrating the drum and the second driving device in the washing machine shown in FIG. 1. FIG. 6 is a rear view of the water tub and the driving device shown in FIG. 2. The drawings will be described together to avoid overlapping explanation.

The first driving device 110 for providing power to the pulsator 40 and the second driving device 130 for providing power to the drum 30 may be arranged on a rear surface 23 of the water tub 20.

The first driving device 110 may include a first motor 111 for generating rotational force to rotate the pulsator 40, a first shaft 113 extending rearward from the pulsator 40 and serving as a rotation axis of the pulsator 40, a first pulley 115 connected to the first shaft 113, and a first belt 117 that connects the first motor 111 to the first pulley 115.

The first motor 111 may be fixed to the outside of the water tub 20, and in an embodiment, the first motor 111 may be mounted at the bottom portion 25 of the water tube 20.

The first motor 111 may include a first motor shaft 11a, which may extend farther to the rearward direction of the main body 10 than a second motor shaft 131a, which will be described later, does. With this structure, the washing machine 1 may be configured such that a first rotation path P1 formed by the first belt 117 connected to the first motor shaft 111a does not overlap a second rotation path P2 formed by a second belt 137 coupled to the second motor shaft 131a. That is, the first belt 117 may be arranged not to interfere with the second belt 137.

The first motor 111 may be a motor that is able to make regular rotation and reverse rotation. Hence, the first motor 111 may selectively rotate the pulsator 40 in one of the same direction as a rotation direction of the drum 30 and the opposite direction from the rotation direction of the drum 30. The first motor 111 may be a brushless direct current (BLCD) motor.

The first shaft 113 may be connected to the rear surface of the pulsator 40, and may extend from the pulsator 40 along the rotation axis of the pulsator 40. In other words, the first shaft 113 may extend rearward from the pulsator 40. Although the first shaft 113 may be formed separately from the pulsator 40 and coupled to the pulsator 40 as in FIG. 3, the first shaft 113 may be integrally formed with the pulsator 40.

An end of the first shaft 113 may be connected to the pulsator 40, and the other end of the first shaft 113 may be connected to the first pulley 115 as will be described later. With this structure, the first shaft 113 may convey the power that the first pulley 115 receives from the first motor 111 to the pulsator 40 to rotate the pulsator 40.

The first shaft 113 may be rotationally inserted to the inside of a second shaft 133. Accordingly, the first shaft 113 may be rotated in the same direction with the second shaft 133 or in the opposite direction from the second shaft 133.

The first shaft 113 is formed to be longer than the second shaft 133, and may be put into the second shaft 133 to protrude from both ends of the second shaft 133.

One end of the first shaft 113 may be connected to the pulsator 40 and the other end of the first shaft 113 may be connected to the first pulley 115. The first pulley 115 may include a first base 115a connected to the first shaft 113, a first coupler 115c coupled to the first belt 117, which will be described later, to guide rotation of the first belt 117, and a first extension 115b for connecting the first base 115a and the first coupler 115c.

The other end of the first shaft 113 is fixed to the first base 115a, and accordingly, when the first pulley 115 is rotated, the first shaft 113 is rotated along with the first pulley 115.

The first coupler 115c may be provided along the perimeter of the first pulley 115 and connected to the first belt 117. As the first coupler 115c is connected to the first belt 117, the first pulley 115 may receive driving force generated from the first motor 111. The first pulley 115 may convey the driving force received through the first coupler 115c to the first shaft 113 connected to the first base 115a.

At least one or more first extensions 115b may extend in the radial direction of the first shaft 113 to connect the first base 115a and the first coupler 115c. However, unlike what is shown in FIG. 3, for the first extensions 115b, one plate may extend from the first base 115a to the first coupler 115c. The first extension 115b may convey driving force that the first coupler 115c receives from the first motor 111 to the first base 115a.

The first belt 117 may connect the first motor 111 to the first pulley 115 to convey the power of the first motor 111 to the first pulley 115. Specifically, the inner side of the first belt 117 may contact and may be coupled to the first motor shaft 111a of the first motor 111 and the first coupler 115c of the first pulley 115. In other words, rotational movement of the first belt 117 may be guided by the first motor shaft 111a of the first motor 111 and the first coupler 115c of the first pulley 115.

The first belt 117 may be arranged to be separated from the second belt 137 by a certain distance d. This prevents the second belt 137 from being interfered by the first belt 117.

Referring to FIG. 5, the second driving device 130 may include a second motor 131 for generating rotational force to rotate the drum 30, the second shaft 133 extending rearward from the drum 30 and serving as a rotation axis of the drum 30, a second pulley 135 connected to the second shaft 133, and the second belt 137 that connects the second motor 131 to the second pulley 135.

The second motor 131 may be fixed to the outside of the water tube 20 to provide power to the drum 30. As in FIG. 6, the second motor 131 may be mounted in a portion of a lower end of the circumferential surface of the water tub 20, which is different from a portion of the lower end of the circumferential surface of the water tub 20 to which the first motor 111 is fixed.

The second motor 131 may include a second motor shaft 131a, which may extend less to a rearward direction of the main body 10 than the motor shaft 111a of the first motor 111 does. With this structure, the washing machine 1 may be configured such that the second rotation path P2 formed by the second belt 137 connected to the second motor shaft 131a does not overlap the first rotation path P1 formed by the first belt 117 connected to the first motor shaft 111a.

Like the first motor 111, the second motor 131 may be a motor that is able to make regular rotation and reverse rotation. Hence, the second motor 131 may rotate the drum 30 in a first direction or a second direction different from the first direction. Like the first motor 111, the second motor 131 may be an BLDC motor.

The second shaft 133 may be connected to the rear surface of the drum 30, and may extend from the drum 30 along the rotation axis of the drum 30.

The second shaft 133 may be a rotation axis of the pulsator 40. The second shaft 133 may pass through the rear surface 25 of the water tub 20 to connect the drum 30 to the second pulley 135. The second shaft 133 may be formed separately from the pulsator 40 and coupled to the drum 30, without being limited thereto, but may be integrally formed with the drum 30.

A second bearing 134 may be arranged on the outer circumferential surface of the second shaft 133 to rotationally support the second shaft 133. The second bearing 134 may be fixed to the water tub 20.

The second shaft 133 may have a hollow formed therein for the first shaft 113 to be rotationally inserted thereto. Specifically, the hollow of the second shaft 133 may be formed to have a larger diameter than the first shaft by a certain size so that the first shaft 113 may be inserted to and rotated in the hollow. With this structure, the second shaft 133 may be rotated in the same direction with the first shaft 113 or in the opposite direction from the first shaft 113.

The second shaft 133 is formed to be shorter than the first shaft 113 so that the first shaft 113 protrudes from both ends of the second shaft 133. With this structure, the rear plate of the drum 30 connected to an end of the second shaft 133 may be located farther back than the pulsator 40 connected to an end of the first shaft 113, and the second pulley 135 connected to the other end of the second shaft 133 may be located closer to the drum 30 than the first pulley 115 connected to the other end of the first shaft 113.

The second pulley 135, a second base 135a, a second coupler 135c and a second extension 135b may play the aforementioned roles in relation to the drum 30 to convey driving force to the drum 30.

The second belt 137 may connect the second motor 131 to the second pulley 135 to convey the power of the second motor 131 to the second pulley 135. Specifically, the inner side of the second belt 137 may contact and may be coupled to the second motor shaft 131a of the second motor 131 and the second coupler 135c of the second pulley 135. In other words, rotational movement of the second belt 137 may be guided by the second motor shaft 131a of the second motor 131 and the second coupler 135c of the second pulley 135.

The second belt 137 may be arranged to be separated from the first belt 117 by the certain distance d. This prevents the second belt 137 from being interfered by the first belt 117.

In an embodiment of the disclosure, the second belt 137 may be the same belt as the first belt 117. Specifically, the second belt 137 may be provided to have the same length as the length of the first belt 117.

In other words, the first motor 111, the first pulley 115 and the first belt 117 of the first driving device 110 of the washing machine 1 may use the same driving motor, pulley and belt as the second motor 131, the second pulley 135 and the second belt 137 of the second driving device 130, respectively.

In the meantime, the components of the washing machine 1 may be arranged in different positions. For example, the drum 30 may be rotated according to the first driving device 110 and associated components, and the pulsator 40 may be rotated according to the second driving device 130 and associated components.

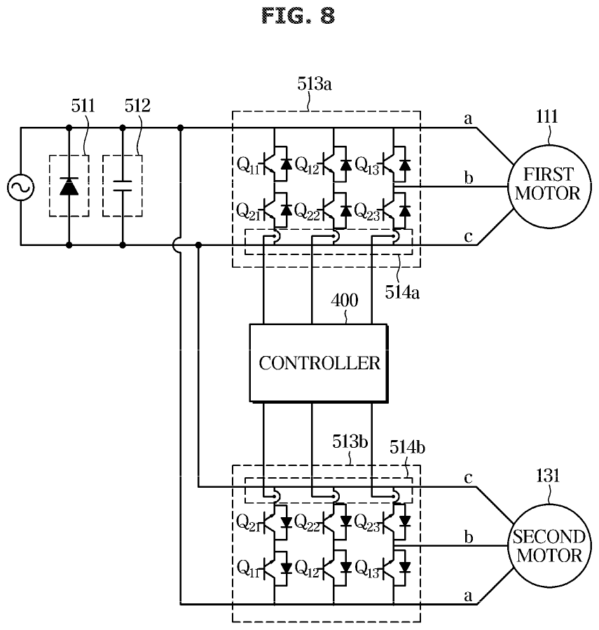

FIG. 7 is a control block diagram of the washing machine, according to an embodiment of the disclosure, and FIG. 8 is a circuit diagram of a driving circuit included in a driver of FIG. 7.

Referring to FIG. 7, the washing machine 1 may include a control panel 200 for receiving an operation command from the user, a memory 300 for storing various information used for controlling the washing machine 1, a driving device 100 for providing power to the pulsator 40 and the drum 30, a driver 500 for controlling the driving device 100, and a controller 400 for controlling the components of the washing machine 1.

Specifically, the control panel 200 receives an operation command for the washing machine 1 from the user, and displays operation information of the washing machine 1 for the user. The control panel 200 includes an input interface for receiving an operation command from the user, and a display module for displaying operation information.

The input interface may receive a command to power on/off the washing machine 1, a command to select a laundry mode, a command to supply water, a command to select volume of water to be supplied, a command to select water temperature, a command to start/pause/stop a laundry course, etc.

The laundry course as herein used refers to a standard course offered to the user, which is set by the manufacturer when the washing machine 1 is manufactured, and is specifically classified into preliminary washing, main washing, rinsing and dehydrating.

The preliminary washing is to perform rough washing for a preset period of time before main washing, and begins with a small amount of detergent being put into the drum 30 along with the water. The rinsing is an operation to remove the detergent contained in the water by throwing in water without detergent, which may be performed as many as the preset number of times. The dehydrating is an operation to remove water contained in the drum 30, thereby removing the water soaked in the clothes by mechanical energy. Hereinafter, the laundry course may include all the preliminary washing, the main washing, the rinsing and the dehydrating, or may refer to a specific detailed course.

The input interface may employ a pressure-type switch or a touch pad, and the display module may employ a liquid crystal display (LCD) panel or a light emitting diode (LED) panel.

The input interface and the display module of the control panel 200 may be provided separately, or alternatively, a touch screen panel (TSP) in which the input interface and the display module are integrally formed may be employed. How to implement the input interface and the display module is not, however, limited to the aforementioned examples, but may have other various methods within the scope that may be easily designed by those of ordinary skill in the art.

The memory 300 may store various data, control programs, or applications for driving and controlling the washing machine 1. For example, the memory 300 may store a driving program or application for the washing machine 1 to control operations of the washing machine 1 and provide a visualized control screen on the display module of the control panel 200.

For example, the memory 300 may store operation sequence information, operation start time information and rotational direction information of the drum 30 and the pulsator 40, and store other information required to control operations of the drum 30 and the pulsator 40 as well.

In an embodiment, the memory 300 may store operation information in advance about the rotation speed of the second motor 133 that provides driving force to the drum 30 during the dehydrating course. Specifically, the memory 300 may store operation information for gradually increasing the rotation speed such as 400 revolutions per minute (rpm), 800 rpm and 1200 rpm after the dehydrating course is started.

The memory 300 may include at least one type of storage medium including a flash memory, a hard disk, a multimedia card micro type memory, a card type memory (e.g., SD or XD memory), a Random Access Memory (RAM), a Static Random Access Memory (SPAM), a Read-Only Memory (ROM), an Electrically Erasable Programmable Read-Only Memory (EEPROM), a Programmable Read-Only Memory (PROM), a magnetic memory, a magnetic disk, and an optical disk. The memory 300 is not, however, limited to those types, but may be implemented in other various forms well known to those of ordinary skill in the art.

The driving device 100 is to send a control signal generated by the controller 400 to the drum 30 or the pulsator 40 as driving force, and includes the first driving device 110 and the second driving device 130 as described above in connection with FIGS. 1 to 6.

The first driving device 110 drives the pulsator 40 based on a control command generated by the controller 400, and the second driving device 130 drives the drum 30 based on a control command generated by the controller 400.

When the pulsator 40 and the drum 30 are rotated by the driving device 100 in the same direction, the washing machine 1 may perform the same operation as a front-loading washing machine.

When the pulsator 40 and the drum 30 are rotated in the opposite directions, the washing machine 1 may move the clothes not only in the vertical direction but also in the front-back direction, unlike the front-loading washing machine that does the laundry by dropping the clothes substantially (e.g., only) in the vertical direction.

Furthermore, after the laundry course is started, the washing machine 1 may activate the drum 30 and the pulsator 40 sequentially. Specifically, the washing machine 1 may activate the drum 30 first and after the lapse of a preset period of time, activate the pulsator 40, or activate the pulsator 40 first and after the lapse of a preset period of time, activate the drum 30.

The driver 500 conveys power to the driving device 100 based on a control signal generated by the controller 400 to operate the driving device 100. Specifically, the driver 500 may control the magnitude of a current flowing to the driving motor 111 or 131 included in the driving device 100, and eventually control the rotation speed of the driving motor 111 or 131.

A configuration and operation of the driver 500 will now be described in detail with reference to FIG. 8.

Referring to FIG. 8, the driver 500 includes a rectifying circuit 511 for rectifying alternate current (ac) power input from an external power source AC, a smoothing circuit 512 for eliminating ripples of the rectified power, inverters 513a and 513b, and current detection circuits 514a and 514b for detecting currents flowing between the inverter 513a or 513b and the driving motor 111 or 131.

The rectifying circuit 511 may rectify 50 Hz or 60 Hz of ac power supplied from the external power AC. Specifically, the rectifying circuit 511 may control voltage polarity such that an ac voltage applied in both positive and negative directions is applied in the positive direction, and control the current direction such that an ac current flowing in both positive and negative directions flows in the positive direction. For example, the rectifying circuit 511 may include a diode bridge in which a plurality of diodes D1, D2, D3 and D4 are connected in the form of a bridge, as shown in FIG. 8.

The smoothing circuit 512 may eliminate ripples of the voltage output from the rectifying circuit 511 to output a voltage of a constant magnitude. That is, the smoothing circuit 512 may output a constant voltage by regulating the magnitude of the voltage output by the rectifying circuit 511. For example, the smoothing circuit 512 may include a capacitor having a pair of conductive plates facing each other and a dielectric arranged between the conductor plates, as shown in FIG. 8.

The magnitude of the constant voltage (i.e., a direct current (dc) link voltage) output by the smoothing circuit 512 is related to capacitance of the capacitor included in the smoothing circuit 512, and the dc link voltage is dropped as much as a current consumed in the operation of the driving motor 111 or 131. In other words, as more current is consumed by the driving motor 111 or 131, the smoothing circuit 512 requires a capacitor with large capacitance.

To separately control the drum 30 and the pulsator 40 included in the washing machine 1, capacitance of the capacitor required for the smoothing circuit 512 increases with an increase in the number of the driving motors 111 and 131.

When the drum 30 operates, the clothes received in the drum 30 may be engaged in falling motion. Furthermore, the falling motion of the clothes may cause the pulsator 40 that has not been operated to be rotated. When the operation of the pulsator 40 causes overcurrent to the first motor 111, a drastic drop of the dc link voltage occurs. The drastic drop of the dc link voltage may lead to an operation failure and control instability.

To address this, the washing machine 1 controls the current flowing to the first motor 111 to be zero (0) ampere (A) to prevent occurrence of counter electromotive force to the first motor 111. This will be described later in detail with reference to other drawings.

The inverters 513a and 513b control operation of the motors 111 and 131 by converting the dc voltage output from the smoothing circuit 512 to pulsed three-phase ac currents having an arbitrary variable frequency by pulse width modulation (PWM). The inverters 513a and 513b may each correspond to an intelligent power module (IPM) for controlling power supply to rotate the motor 111 or 131. The inverters 513a and 513b may each include a plurality of switching circuits Q11 to Q23, which may be implemented with high-voltage switches such as high voltage bipolar junction transistors, high voltage field effect transistors, or IGBTs (insulated gate bipolar transistors), and free wheeling diodes.

The inverters 513a and 513b may each include a temperature sensor (not shown) to detect temperature of the inverter 513a or 513b. The temperature sensor may be mounted on one side of a printed circuit board. In general, the temperature of the inverter 513a or 513b is proportional to the magnitude of the current flowing in the inverter 513a or 513b. The second motor 131 consumes more current with an increase in load due to the weight of the laundry. Furthermore, the second motor 131 may consume even more current not only with an increase in load due to the weight of the laundry, but also with an increase in load due to the rotation of the pulsator 40 in the opposite direction. In this case, the temperature of the inverter 513a or 513b may rise depending on at least two factors, and the inverter 513a or 513b may detect the rising temperature through the temperature sensor arranged therein and inform the detected temperature to the controller 400.

The temperature sensor of the inverter 513a or 513b may include various types of sensors. For example, the temperature sensor may include thermocouples for detecting electromotive force at a particular temperature, resistance temperature detectors, thermistors, bimetal thermometers, etc.

The washing machine 1 controls the drum 30 and the pulsator 40 separately. Hence, the driver 50 may divide dc power output from the smoothing circuit 512 and send the divided dc power to the first inverter 513a for rotating the drum 30 and the second inverter 513b for rotating the pulsator 40.

The current detection circuit 514a or 514b may detect a current flowing between the inverter 513a or 514b and the driving motor 111 or 131. The controller 400 may determine rotation speed of the driving motor 111 or 131 based on the magnitude of the current detected by the current detection circuit 514a or 514b.

In other words, the washing machine 1 determines rotation speeds of the drum 30 and the pulsator 40 through the current detection circuits 514a and 514b. As described above, even when the pulsator 40 is rotated by the clothes in motion along with rotation of the drum 30, the current detection circuit 514a may detect rotation speed of the pulsator 40, and based on which, the washing machine 1 may determine a current state of the laundry in the drum 30.

The current detection circuits 514a and 514b may each include a current transformer (CT) for proportionally reducing the magnitude of the driving current, and an ampere meter for detecting the magnitude of the proportionally reduced current. In other words, the current detection circuit 514a or 514b may use the CT to proportionally reduce the magnitude of the driving current, and then detect a current by measuring the magnitude of the proportionally reduced current.

The controller 400 controls overall operation of the washing machine 1 and signal flows between the components in the washing machine 1. When a control command is input from the user or a preset condition is met, the controller 400 may run a washing machine control program or application stored in the memory 300.

The controller 400 controls the drum 30 and the pulsator 40 according to the user command from the control panel 200. In other words, the controller 400 sequentially rotates the pulsator 40 and the drum 30 based on the user command and preset operation information.

For example, the controller 400 rotates the drum 30 first. The drum 30 gains rotation speed according to the operation information stored in the memory 300 and a preset time and operation information according to a control signal from the controller 400.

While rotating the drum 30, the controller 400 inhibits generation of counter electromotive force by controlling the magnitude of the current flowing to the first motor 111 for providing driving force to the pulsator 40 to be 0 A.

The controller 400 operates the first motor 111 when the rotation speed of the drum 30 reaches a preset speed. Specifically, the controller 400 may control the first motor 111 in a different method depending on the rotation speed of the pulsator 40 relatively rotated by the laundry.

For example, the pulsator 40 may not be rotated when the load of the laundry rotated by the drum 30 or due to instantaneous shift of the laundry. As the magnitude of the current flowing to the first motor 111 is 0 A, the rotation speed of the pulsator 40 is 0 rpm. When the rotation speed of the drum 30 reaches a preset speed, the controller 400 increases the rotation speed of the first motor 111 from 0 rpm to the current rotation speed of the drum 30.

In another example, the pulsator 40 may be rotated by falling motion of the laundry received in the drum 30. When the drum 30 reaches the preset speed while the pulsator 40 is rotating, the controller 400 increases the current rotation speed of the first motor 111 of the pulsator 40. Alternatively, the controller 400 calculates a speed compensation rate based on the actual rotation speed of the pulsator 40 and the current rotation speed of the drum 30, and determines rotation speed of the first motor 111 by applying the speed compensation rate. In other words, the controller 40 increases the rotation speed of the first motor 111 based on the determined rotation speed.

Based on this, the washing machine 1 may prevent dc link voltage drop that may be caused by a difference between actual rotation speed of the pulsator 40 and the rotation speed of the first motor 111, and seek control stability. This will be described later in more detail with reference to other drawings.

In the meantime, the controller 400 may include at least one processor, a read only memory (ROM) that stores a washing machine control program or application for controlling the washing machine 1, and a random access memory (RAM) for storing signals or data input from the outside of the washing machine 1 or being used as a storage section corresponding to various tasks performed by the washing machine 1. Hereinafter, the ROM and RAM of the controller 400 may be interpreted as including the ROM and RAM of the memory 300.

The washing machine 1 may further include other various components than those shown in FIGS. 7 and 8, and relative positions of the components may be changed according to the performance or structure of the system.

The configurations and their operations of the washing machine 1 have thus far been described above according to the disclosure. Based on the configurations, a method of controlling the washing machine 1 will now be described in detail.

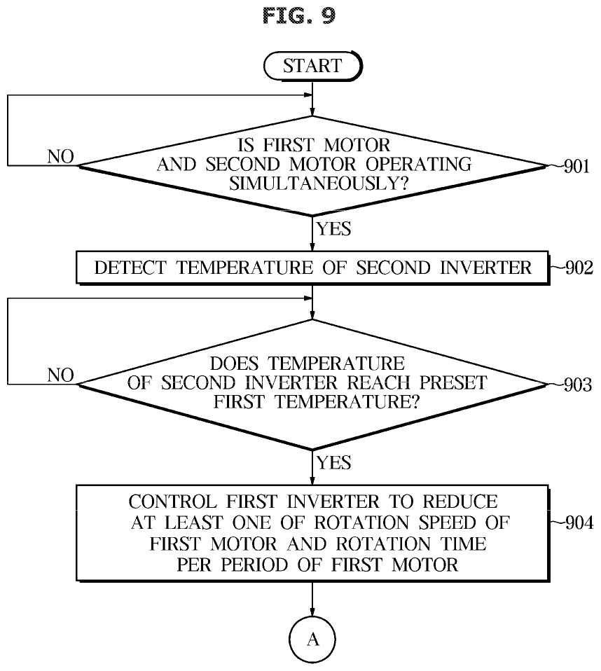

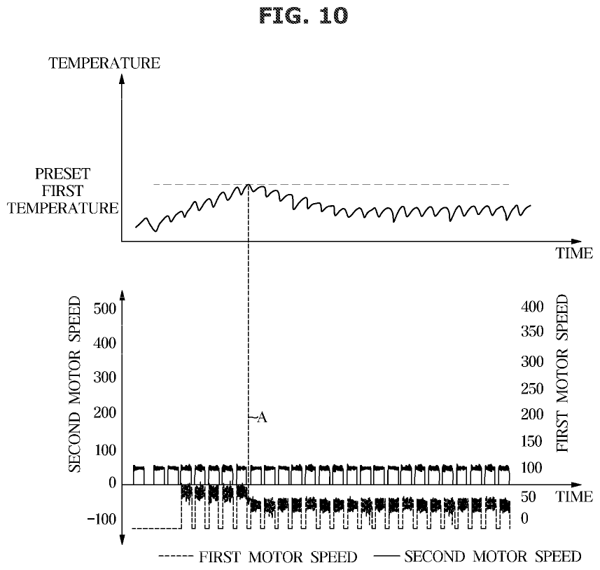

FIG. 9 is a flowchart of a method of controlling a washing machine, according to an embodiment, and FIG. 10 is diagram referred to for describing the flowchart shown in FIG. 9.

The controller 400 determines whether the first motor 111 and the second motor 131 are operated at the same time, in 901. This embodiment is to relieve an increase in load of the second motor 131 of the drum 30 due to rotation of the pulsator 40 or on the contrary, relieve an increase in load of the first motor 111 of the pulsator 40 due to rotation of the drum 30, when the drum 30 and the pulsator 40 are rotated in opposite directions. Hence, before controlling the first motor 111, the controller 400 determines whether the first motor 111 and the second motor 131 are operated simultaneously, and determines whether the first motor 111 and the second motor 131 are rotated in the opposite directions.

The second inverter 513b detects temperature of the second inverter 513b through the temperature sensor equipped therein, in 902. The temperature of the second inverter 513b is proportional to the magnitude of a current to rotate the drum 30, and the temperature of the second motor 131 of the drum 30 may be estimated based on the temperature of the second inverter 513b. The second inverter 513b provides data about the detected temperature to the controller 400.

The controller 400 determines whether the temperature of the second inverter 513b reaches a preset first temperature, in 903. The preset first temperature corresponds to a reference temperature to prevent an increase in load on the second motor 131 of the drum 30 due to reverse rotation of the pulsator 40. For example, the preset first temperature may be 60 degrees Celsius, or may have any value depending on the motor specifications and settings of the washing machine.

When the temperature of the second inverter 513b does not reach the preset first temperature in 903, the controller 400 stays in the existing operation specifications and keeps detecting the temperature of the second inverter 513b until the end of the course of the washing machine.

When the temperature of the second inverter 513b reaches the preset first temperature in 903, the controller 400 controls the first inverter 513a to reduce at least one of the rotation speed of the first motor 111 or the rotation time per period of the first motor 111, in 904. In other words, the controller 400 may reduce at least one of the rotation speed of the pulsator 40 or rotation time per period of the pulsator 40 when there is a rise in temperature due to overload on the second motor 131 of the drum 30.

In an embodiment, when the temperature of the second inverter 513b reaches the preset first temperature, the controller 400 may control the first inverter 513a to reduce only the rotation speed of the first motor 111. Furthermore, in an embodiment, when the temperature of the second inverter 513b reaches the preset first temperature, the controller 400 may control the first inverter 513a to reduce only the rotation time per period of the first motor 111. Moreover, in an embodiment, when the temperature of the second inverter 513b reaches the preset first temperature, the controller 400 may control the first inverter 513a to reduce both the rotation speed of the first motor 111 and the rotation time per period of the first motor 111.

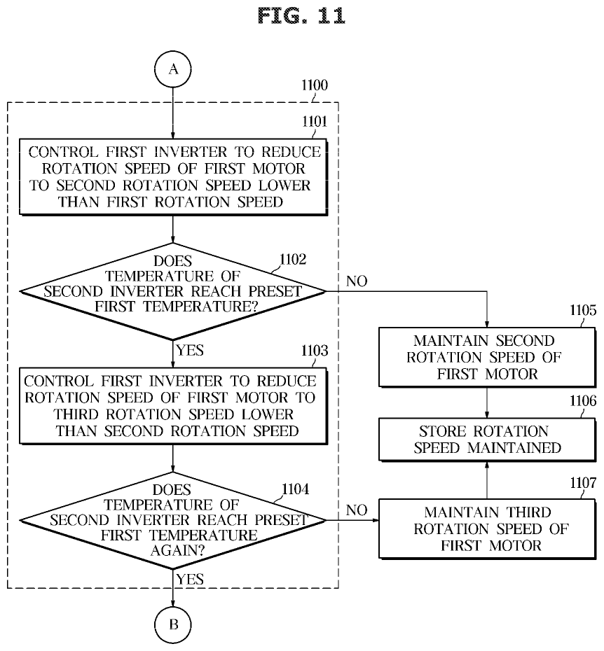

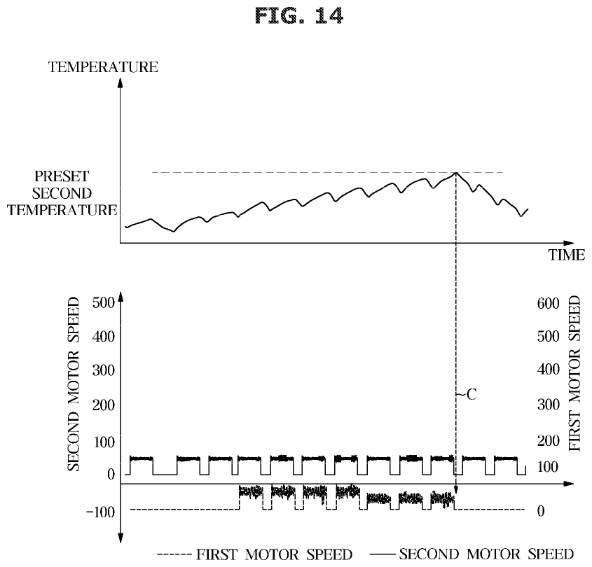

In the meantime, in the embodiment of FIGS. 9 and 10, the rotation time per period of the first motor 111 may be controlled instead of the rotation speed of the first motor 111 or both the rotation speed of the first motor 111 and the rotation time per period of the first motor 111 may be controlled based on the same condition. This may be equally applied to FIGS. 11 and 14.

Referring to FIG. 10, the temperature of the second inverter 513b continues to rise due to rotation of the drum 30 and reverse rotation of the pulsator 40 after a laundry course is started, and reaches the preset first temperature at point A. Basically, the temperature of the second motor 131 rises due to rotation of the drum 30, and may further rise due to the weight of the laundry and the reverse rotation of the pulsator 40.

The controller 400 determines that the temperature of the second inverter 513b has reached the preset first temperature at the point A, and controls the first inverter 513a to reduce the rotation speed of the first motor 111 after the point A. The rotation speed of the first motor 111 after the point A is maintained to have a value obtained by subtracting a specified value from the rotation speed of the first motor 111 before the point A.

Furthermore, the controller 400 determines that the temperature of the second inverter 513b has reached the preset first temperature at the point A, and controls the first inverter 513a to reduce the rotation time per period of the first motor 111 after the point A. The rotation time per period refers to an interval in which the motor is operated in one period. Hence, when the rotation time per period of the first motor 111 is reduced, the load on the second motor 131 may be relieved because the rotation time of the pulsator 40 is reduced in the period of the course of the washing machine.

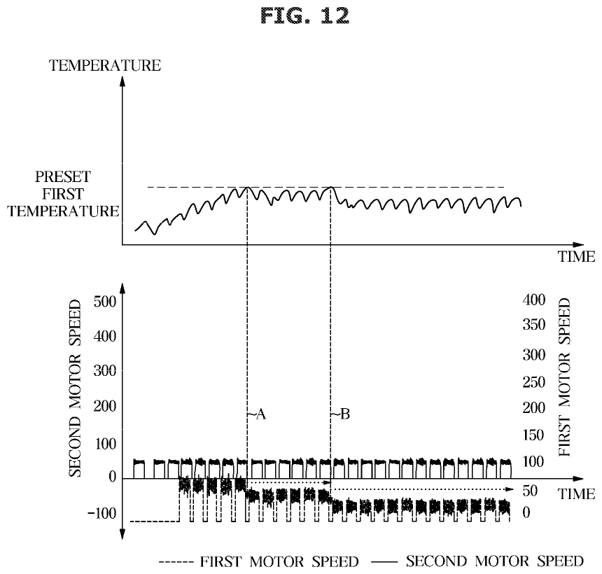

The embodiment described above in connection with FIGS. 9 and 10 is to reduce the rotation speed of the pulsator 40 on a one-time basis, when the temperature of the second inverter 513b reaches a certain level. However, even with this control, overheating of the second motor 131 may not be relieved. This may be solved by a method of controlling the washing machine according to FIGS. 11 and 12.

FIG. 11 is a flowchart of a method of controlling a washing machine, according to an embodiment, and FIG. 12 is diagram referred to for describing the flowchart shown in FIG. 11.

When the temperature of the second inverter 513b reaches the preset first temperature, the controller 400 controls the first inverter 513a to reduce the rotation speed of the first motor 111 to a second rotation speed lower than a first rotation speed, in 1101. The temperature of the second inverter 513b may be reduced in 1101, but may rise again due to constant rotation of the motor. When the temperature of the second inverter 513b rises again after the one-time control, the controller 400 may further reduce the number of revolutions of the first motor 111 to prevent overheating of the second motor 131 and the second inverter 513b.

The controller 400 determines whether the temperature of the second inverter 513b reaches the preset first temperature again after the first control, in 1102.

When the temperature of the second inverter 513b stays below the preset first temperature without reaching the preset first temperature in 1102, the controller 400 maintains the first motor 111 at the second rotation speed in 1105. In an embodiment, when the temperature of the second inverter 513b does not reach the preset first temperature, the controller 400 controls the second rotation speed of the first motor 111 to be maintained until the end of the course of the washing machine. Accordingly, the pulsator 40 is driven at the second rotation speed until the end of the course of the washing machine. The controller 400 then stores the second rotation speed, which is the speed maintained, in the memory 300, in 1106.

When the temperature of the second inverter 513b reaches the preset first temperature again in 1102, the controller 400 controls the first inverter 513a to reduce the rotation speed of the first motor 111 to a third rotation speed lower than the second rotation speed, in 1103.

Referring to FIG. 12, the controller 400 controls the first inverter 513a so that the rotation speed of the first motor 111 is reduced from the first rotation speed to the second rotation speed at the point A and the rotation speed of the first motor 111 is reduced from the second rotation speed to the third rotation speed at the point B. In this case, the rotation speed may be reduced by a specified value and may maintain the reduced speed, and the specified value, which is an amount of reduction of the rotation speed, may be the same at both points A and B. Furthermore, the amount of reduction of the rotation speed may be in inverse proportion to a re-arrival time of the temperature of the second inverter 513b.

Furthermore, the rotation time per period of the first motor 111 may also be reduced by a specified value and may maintain the reduced time, and the specified value, which is an amount of reduction of the rotation time per period, may be the same at both points A and B (not shown). Furthermore, the amount of reduction of the rotation time per period may be in inverse proportion to a re-arrival time of the temperature of the second inverter 513b.

When the temperature of the second inverter 513b stays below the preset first temperature without reaching the preset first temperature in 1104 controller 400, the controller 400 maintains the first motor 111 at the third rotation speed in 1107. In an embodiment, when the temperature of the second inverter 513b does not reach the preset first temperature, the controller 400 controls the third rotation speed of the first motor 111 to be maintained until the end of the course of the washing machine. Accordingly, the pulsator 40 is driven at the third rotation speed until the end of the course of the washing machine. The controller 400 then stores the third rotation speed, which is the speed maintained, in the memory 300, in 1106.

In an embodiment, the washing machine includes an input interface (e.g., the control panel 200) for receiving an operation command from the user and the memory 300, and the memory 300 memorizes and stores a proper rotation speed that prevents overheating according to the control to reduce rotation speed of the first motor 111 according to the disclosure. For example, the rotation speed maintained in 1105 or 1106 may be stored. In this case, when the course is terminated with the rotation speed maintained, and afterward, the same laundry course as before is performed according to an operation command from the user, the controller 400 may start driving the first motor 111 according to the stored rotation speed.

The aforementioned steps 1101 to 1104 (1100) may be repeatedly performed until the end of the course of the washing machine, keeping the temperature of the second inverter 513b below the preset first temperature. Specifically, each time the temperature of the second inverter 513b reaches the preset first temperature, the controller 400 may control the first inverter 513a to reduce the rotation speed of the first motor 111 by a specified value. In this case, the specified value, which is an amount of reduction of the rotation speed, may all be the same, and as described above, may be in inverse proportion to a re-arrival time of the temperature of the second inverter 513b.

In an embodiment, each time the temperature of the second inverter 513b reaches the preset first temperature, the controller 400 controls the first inverter 513a to reduce the rotation speed of the first motor 111 by the specified value. Such control of the reducing may be performed until the end of the course of the washing machine, and the specified value, which is an amount of reduction of the rotation speed, may all be the same, and as described above, may be in inverse proportion to a re-arrival time of the temperature of the second inverter 513b.

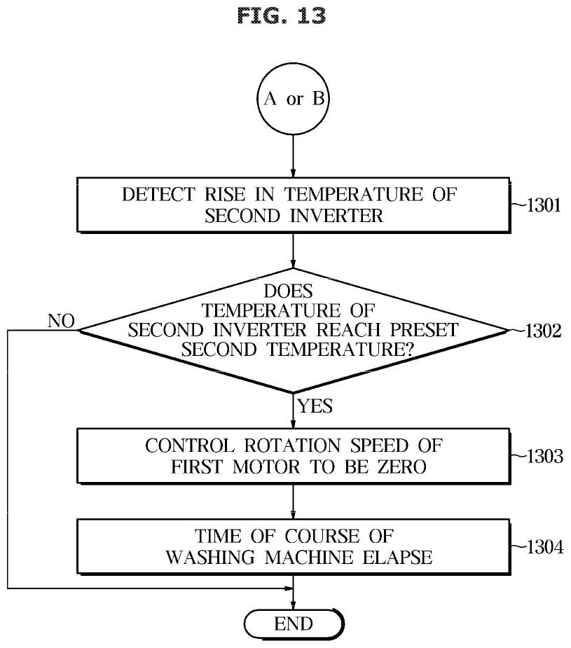

In the meantime, even though the operation of the first motor 111 is relieved through step 1100, overheating of the second motor 131 may continue. Hence, additional control is required in addition to the relieving of the rotation speed of the first motor 111, which will be described in detail with reference to FIGS. 13 and 14.

FIG. 13 is a flowchart of a method of controlling a washing machine, according to an embodiment, and FIG. 14 is diagram referred to for describing the flowchart shown in FIG. 13.

The controller 400 detects a rise in temperature of the second inverter 513b in 1301, and determines whether the temperature of the second inverter 513b reaches a preset second temperature in 1302. In this case, the preset second temperature has a value higher than the preset first temperature, which may be, for example, 70 to 75 degrees Celsius, and may have various values depending on motor specifications and settings of the washing machine.

When the temperature of the second inverter 513b reaches the preset second temperature, the controller 400 controls the rotation speed of the first motor 111 to 0, in 1303. Accordingly, the pulsator 40 comes to a complete stop, preventing overload of the drum 30 due to the reverse rotation of the pulsator 40.

In this case, the controller 400 stops driving the pulsator 40 until the time of the course of the washing machine elapses in 1304, but performs the course only with rotation of the drum 30 (see FIG. 14).

Meanwhile, the embodiments of the disclosure may be implemented in the form of a recording medium for storing instructions to be carried out by a computer. The instructions may be stored in the form of program codes, and when executed by a processor, may generate program modules to perform operation in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The machine-readable storage medium may be provided in the form of a non-transitory recording medium. The term ‘non-transitory recording medium’ may mean a tangible device without including a signal, e.g., electromagnetic waves, and may not distinguish between storing data in the recording medium semi-permanently and temporarily. For example, the non-transitory recording medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

The embodiments of the disclosure have thus far been described with reference to accompanying drawings. The disclosure may be practiced in other forms than the embodiments of the disclosure as described above without changing the technical idea or essential features of the disclosure. The above embodiments of the disclosure are only by way of example, and should not be construed in a limited sense.

Although the present disclosure has been described with various embodiments, various changes and modifications may be suggested to one skilled in the art. It is intended that the present disclosure encompass such changes and modifications as fall within the scope of the appended claims.

What is claimed is:

1. A washing machine comprising:
a main body that includes a laundry inlet;
a water tub arranged in the main body for storing water;
a drum arranged to be rotatable in the water tub;
a pulsator arranged in the drum and rotating in an opposite direction from a rotational direction of the drum;
a first motor configured to provide driving force to the pulsator;
a second motor configured to provide driving force to the drum;
a first inverter configured to control a current applied to the first motor;
a second inverter that includes a temperature detection function and that is configured to control a current applied to the second motor; and
a controller configured to control the first inverter to reduce at least one of rotation speed of the first motor or rotation time per period of the first motor, in response to a determination that a temperature of the second inverter is equal to a preset first temperature.

2. The washing machine of claim 1, wherein the controller is configured to control the first inverter to:
reduce the rotation speed of the first motor to a second rotation speed less than a first rotation speed, in response to a first determination the temperature of the second inverter is equal to the preset first temperature; and
reduce the rotation speed of the first motor to a third rotation speed less than the second rotation speed, in response to a second determination the temperature of the second inverter is equal to the preset first temperature again after the first determination.

3. The washing machine of claim 2, wherein the controller is configured to control the first inverter to reduce the rotation speed of the first motor by a specified value each time the temperature of the second inverter is equal to the preset first temperature.

4. The washing machine of claim 3, wherein the controller is configured to control the first inverter to reduce the rotation speed of the first motor to 0, in response to a determination the temperature of the second inverter is equal to a preset second temperature.

5. The washing machine of claim 3, wherein the controller is configured to maintain the reduced rotation speed of the first motor until the end of a course of the washing machine unless the controller obtains a determination that the temperature of the second inverter is equal to the preset first temperature.

6. The washing machine of claim 5, further comprising:
an input interface configured to receive, from a user, an operation command to perform a same course as the course performed before the operation command is received; and
a memory configured to store the reduced rotation speed the first motor maintained,
wherein the controller is configured to, in response to receiving the operation command after the end of the course of the washing machine, start the same course of the washing machine at the reduced rotation speed the first motor maintained.

7. The washing machine of claim 1, wherein the controller is configured to control the first inverter to:
reduce the rotation time per period of the first motor to a second rotation time per period less than the rotation time per period, in response to a first determination the temperature of the second inverter is equal to the preset first temperature; and
reduce the rotation time per period of the first motor to a third rotation time per period less than the second rotation time per period, in response to a second determination the temperature of the second inverter is equal to the preset first temperature again after the first determination.

8. The washing machine of claim 7, wherein the controller is configured to control the first inverter to reduce the rotation time per period of the first motor by a specified value each time the temperature of the second inverter is equal to the preset first temperature.

9. The washing machine of claim 8, wherein the controller is configured to control the first inverter to reduce the rotation time per period of the first motor to 0 in response to a determination the temperature of the second inverter is equal to a preset second temperature.

10. The washing machine of claim 9, wherein the controller is configured to maintain the reduced rotation time per period of the first motor until the end of a course of the washing machine unless the controller obtains a determination that the temperature of the second inverter is equal to the preset first temperature.

11. The washing machine of claim 10, further comprising:
an input interface configured to receive, from a user, an operation command to perform a same course as the course performed before the operation command is received; and
a memory configured to store the reduced rotation time per period the first motor maintained,
wherein the controller is configured to, in response to receiving the operation command after the end of the course of the washing machine, start the same course of the washing machine with the reduced rotation time per period the first motor maintained.

12. The washing machine of claim 1, wherein the second inverter comprises a temperature sensor configured to detect the temperature of the second inverter.

13. A method of controlling a washing machine that includes a second inverter for controlling a current applied to a second motor for providing driving force to a drum, and a first inverter for controlling a current applied to a first motor for providing driving force to a pulsator which rotates in an opposite direction from a rotational direction of the drum, the method comprising:
detecting a temperature of the second inverter; and
controlling the first inverter to reduce at least one of rotation speed of the first motor or rotation time per period of the first motor, in response to a determination that the temperature of the second inverter is equal to a preset first temperature.

14. The method of claim 13, wherein the controlling of the first inverter comprises controlling the first inverter to:
reduce the rotation speed of the first motor to a second rotation speed less than a first rotation speed, in response to a first determination the temperature of the second inverter reaching the preset first temperature; and
reduce the rotation speed of the first motor to a third rotation speed less than the second rotation speed, in response to a second determination the temperature of the second inverter is equal to the preset first temperature again after the first determination.

15. The method of claim 14, wherein the controlling of the first inverter comprises controlling the first inverter to reduce the rotation speed of the first motor by a specified value each time the temperature of the second inverter is equal to the preset first temperature.

16. The method of claim 15, further comprising controlling the first inverter to reduce the rotation speed of the first motor to 0, in response to a determination the temperature of the second inverter is equal to a preset second temperature.

17. The method of claim 15, further comprising maintaining the reduced rotation speed of the first motor until the end of a course of the washing machine unless a determination is obtained that the temperature of the second inverter is equal to the preset first temperature.

18. The method of claim 13, further comprising controlling the first inverter to:
reduce the rotation time per period of the first motor to a second rotation time per period less than the rotation time per period, in response to a first determination the temperature of the second inverter is equal to the preset first temperature; and
reduce the rotation time per period of the first motor to a third rotation time per period less than the second rotation time per period, in response to a second determination the temperature of the second inverter is equal to the preset first temperature again after the first determination.

19. The method of claim 18, further comprising controlling the first inverter to reduce the rotation time per period of the first motor by a specified value each time the temperature of the second inverter is equal to the preset first temperature.

20. The method of claim 19, further comprising controlling the first inverter to reduce the rotation time per period of the first motor to 0 in response to a determination the temperature of the second inverter is equal to a preset second temperature.
